(19) United States
(12) Patent Application Publication
(10) Pub. No.: US 2013/0148837 A1
(43) Pub. Date: Jun. 13, 2013

(54) MULTI-FUNCTIONAL MICROPHONE ASSEMBLY AND METHOD OF MANUFACTURING THE SAME

(71) Applicants: Dong Sun LEE, Gyeonggi-do (KR); Hyoung Joo KIM, Incheon (KR); Myung Hun HAM, Incheon (KR)

(72) Inventors: Dong Sun LEE, Gyeonggi-do (KR); Hyoung Joo KIM, Incheon (KR); Myung Hun HAM, Incheon (KR)

(21) Appl. No.: 13/707,909

(22) Filed: Dec. 7, 2012

(30) Foreign Application Priority Data
Dec. 9, 2011 (KR) 10-2011-0131763

(51) Int. Cl. H04R 1/04; H04R 31/00

(52) U.S. Cl. CPC H04R 1/04; H04R 31/006
USPC 381/369; 29/592

(57) ABSTRACT

A multi-functional microphone assembly that has a reduced number of components by installing circuit devices for additional functions in a printed circuit board (PCB) of a microphone so as to reduce the number of components and to increase an area of a back electrode plate, thereby improving sound quality, and a method of manufacturing the multi-functional microphone assembly. The multi-functional microphone assembly includes a microphone cell unit; and a printed circuit board (PCB) assembly that is coupled to the microphone cell unit and in which components for a microphone function and components for an additional function are mounted on a PCB on which a metal pattern and a connection terminal are formed.

### CROSS-REFERENCE TO RELATED PATENT APPLICATION

This application claims the benefit of Korean Patent Application No. 10-2011-0131763, filed on Dec. 9, 2011, in the Korean Intellectual Property Office, the disclosure of which is incorporated herein in its entirety by reference.

### BACKGROUND OF THE INVENTION

1. Field of the Invention

The present invention relates to a multi-functional microphone assembly and a method of manufacturing the same, and more particularly, to a multi-functional microphone assembly having a reduced number of components by installing circuit devices for additional functions in a printed circuit board (PCB) of a microphone so that the number of components is reduced and an area of a back electrode plate is improved, thereby the multi-functional microphone assembly improving sound quality, and a method of manufacturing the multi-functional microphone assembly.

2. Description of the Related Art

In general, a condenser microphone is configured such that a structural acoustic module, such as a base, a back electrode plate formed of an electret, a spacer, a diaphragm, a case, or the like is coupled to a printed circuit board (PCB) on which a circuit component such as a field effect transistor (FET) is mounted, includes a condenser that is formed by arranging a conductive thin diaphragm (a moveable electrode) and a back electrode plate (a fixed electrode) in parallel to each other, and generates an electrical acoustic signal by a change of an electric capacity due to sound vibration.

Condenser microphones coupled to various types of devices have been used. For example, an ear set is a small-sized device that is installed on a user's ears and includes a speaker for converting an electric signal into an acoustic signal and a microphone for converting an acoustic signal into an electric signal. Since an ear set is used together with a portable terminal, a user can make a call without holding the portable terminal. An MPEG Audio Layer-3 (MP3) function is basically provided in a portable terminal. Thus, recently, ear sets have been gradually used both for listening to music and conversations. An ear set is classified into a hanger type ear set and an insertion type ear set according to a method of installing the ear set on a user's ears.

In addition, a hanger type ear set includes a body, a speaker installed on an end portion of the body, a microphone installed on the other end portion of the body, and an ear hook that extends from a predetermined portion of the body to be hung on a user's ear. Since a hanger type ear set is easily fixed to a user's ears, hanger type ear sets are being widely used in Bluetooth (wireless) ear sets containing a heavy battery. An insertion type ear set includes speakers installed in a user's ears and a printed circuit board (PCB) assembly that is connected to the speakers via wires, is spaced apart from the speaker by a predetermined length, and includes a microphone and ear-set components mounted thereon. The insertion type ear set is a typical type ear set that is fixed to a user's ears by inserting the speakers into the user's ears.

### SUMMARY OF THE INVENTION

In a conventional multi-functional microphone module, since a microphone printed circuit board (PCB) on which a separate circuit structure for a microphone function is mounted and a PCB on which a circuit structure for an ear set function is mounted are separately used, the microphone function and the ear set function are combined via a surface mounting technology (SMT) process during the manufacture of multi-functional microphone module, and thus, the properties of multi-functional microphone module are changed during the SMT process. In addition, conventionally, when a microphone is used in a product having an additional function, such as an ear set or the like, separate PCBs are mounted, thereby increasing the volume of an entire product and the number of manufacturing processes.

The present invention provides a multi-functional microphone assembly, in which circuit components for additional functions such as an ear set function are installed in a PCB for a microphone PCB such that the number of components and manufacturing processes are reduced to reduce manufacturing costs and a SMT process for a microphone cell unit is omitted to stabilize the properties of a microphone, and a method of manufacturing the multi-functional microphone assembly.

The present invention also provides a multi-functional microphone assembly, in which components for additional functions are installed in a PCB for a microphone function so as to obtain a compact product structure and to increase the size of a back electrode plate, thereby increasing sensitivity, and a method of manufacturing the multi-functional microphone assembly.

The present invention also provides a multi-functional microphone assembly that easily provides various interfaces through a flexible printed circuit board (FPCB), and a method of manufacturing the multi-functional microphone assembly.

According to an aspect of the present invention, there is provided a multi-functional microphone assembly including a microphone cell unit; and a printed circuit board (PCB) assembly that is coupled to the microphone cell unit and in which components for a microphone function and components for an additional function are mounted on a PCB on which a metal pattern and a connection terminal are formed.

The microphone cell unit may be welded on the metal pattern, and a connection surface between the microphone cell unit and the PCB assembly may be sealed by a sealing member. The multi-functional microphone assembly may further include a flexible printed circuit board (FPCB) for interfacing with an external device.

In addition, the PCB assembly may include a PCB having one surface on which a metal pattern is formed and other surface on which a connection terminal is formed, a conductive member that is mounted on the PCB and electrically connects the microphone cell unit and the PCB assembly to each other, components for a microphone function, which are mounted on an upper surface of the PCB, and mount components for additional functions, which respectively are mounted on the upper surface of the PCB and a lower surface of the PCB. The conductive member may include any one of a coil spring, a leaf spring, a connector, a socket, and a pogo pin.

The microphone cell unit may include a microphone cell case including a sound hole and a curing portion; a diaphragm assembly inserted into the microphone cell case; a spacer that is inserted into the microphone cell case and is stacked on the diaphragm assembly; a back electrode plate that is inserted into the microphone cell unit and stacked on the spacer; and an insulating ring base that is inserted into the microphone cell unit, allows the back electrode plate to be properly positioned, and is formed of a non-conductive material for preventing the microphone cell case from being grounded, and internal components may be fixed by a curing or clamping process of the microphone cell case.

The microphone cell case may further include a metal ring base that is inserted into the microphone cell case, is stacked on the insulating ring base, fixes the internal components during the curing or clamping process, permanently transmits a uniform pressure to the microphone cell case, and is formed of metal.

According to another aspect of the present invention, there is provided a method of manufacturing a multi-functional microphone assembly, the method including assembling a microphone cell unit; mounting a conductive member and circuit components on a PCB; adhering the microphone cell unit to the PCB to each other; and sealing a connection surface between the microphone cell unit and the PCB assembly. The method may further include adhering the microphone assembly to an FPCB for interfacing.

In addition, the assembling of the microphone cell unit may include inserting a microphone cell case including a sound hole and a curing portion into a diaphragm assembly; stacking a spacer on the diaphragm assembly; inserting a back electrode plate into an insulating ring base to be coupled to each other; mounting the insulating ring base coupled to the back electrode plate on the spacer; mounting a metal ring base on the insulating ring base; and curing or clamping a curing portion of the microphone cell case.

### BRIEF DESCRIPTION OF THE DRAWINGS

The above and other features and advantages of the present invention will become more apparent by describing in detail exemplary embodiments thereof with reference to the attached drawings in which:

FIG. 1 is an exploded perspective view of a multi-functional microphone assembly according to an embodiment of the present invention;

FIGS. 2A and 2B are perspective views showing a case where a multi-functional microphone assembly is assembled, according to an embodiment of the present invention;

FIG. 3 is an exploded perspective view of a case where a microphone cell unit of FIG. 1 is not assembled, according to an embodiment of the present invention;

FIG. 4 is a perspective view of a case where a microphone cell unit of FIG. 1 is assembled, according to an embodiment of the present invention;

FIG. 5 is an exploded perspective view of a case where a flexible printed circuit board (FPCB) interface of a multi-functional microphone assembly is not assembled, according to an embodiment of the present invention;

FIG. 6 is a perspective view of a case where an FPCB interface of a multi-functional microphone assembly is assembled, according to an embodiment of the present invention;

FIG. 7 is a plan view of the multi-functional microphone assembly of FIG. 6, according to an embodiment of the present invention;

FIG. 8 is a side view of the multi-functional microphone assembly of FIG. 6, according to an embodiment of the present invention;

FIG. 9 is a bottom view of the multi-functional microphone assembly of FIG. 6, according to an embodiment of the present invention; and

FIG. 10 is a side cross-sectional view of the multi-functional microphone assembly of FIG. 6, according to an embodiment of the present invention.

### DETAILED DESCRIPTION OF THE INVENTION

Hereinafter, the present invention will be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. For example, according to the present invention, various functions may be combined with a microphone function. However, according to an embodiment of the present invention, an ear set function is combined with a microphone function.

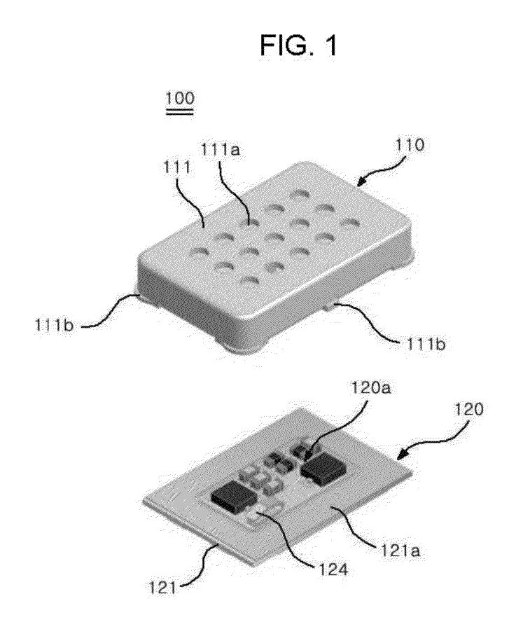

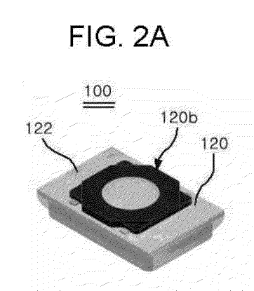

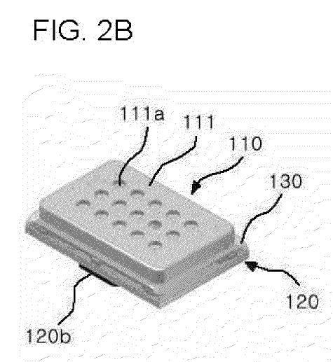

FIG. 1 is an exploded perspective view of a multi-functional microphone assembly 100 according to an embodiment of the present invention. FIGS. 2A and 2B are perspective views showing a case where the multi-functional microphone assembly 100 is assembled, according to an embodiment of the present invention. FIG. 2A is a reversed perspective view and FIG. 2B is a normal perspective view.

Referring to FIGS. 1 and 2, the multi-functional microphone assembly 100 includes a microphone cell unit 110 and a PCB assembly 120 on which components for a microphone function and components for an ear set function are mounted. As described below, the microphone cell unit 110 is integrally adhered to the PCB assembly 120 in order to surround and protect upper mount components 120a mounted on an upper surface of the PCB 121 by welding the welding portion 111b of a case 111 on a metal pattern 121a of the PCB 121 and then sealing a gap between the microphone cell unit 110 and the PCB 121.

The PCB assembly 120 is a multifunctional component obtained by combining a microphone function and an ear set function, and includes the PCB 121 having an upper surface on which the metal pattern 121a is formed and a lower surface on which connection terminals 122 are formed, a conductive member 124 that is attached to the upper surface of the PCB 121 and electrically connects the microphone cell unit 110 and the PCB assembly 120 to each other, the upper mount components 120a mounted on the upper surface of the PCB 121, and lower mount components 120b mounted on the lower surface of the PCB 121.

Although not shown in FIGS. 1 and 2, the PCB assembly 120 may include a harness and terminals for connecting components. The upper mount components 120a may include field effect transistors (FETs) for the microphone function or chip components for the ear set function, such as an amplifier, a capacitor, or a resistor. The lower mount components 120b may include a volume controlling switch for the ear set function, a battery power source, or the like.

In addition, the conductive member 124 may be a conductive component having structural elasticity for transferring signals between the microphone cell unit 110 and the PCB 121 and may be, for example, a coil spring, a leaf spring, a connector, a socket, a pogo pin, or the like.

The multi-functional microphone assembly 100 is manufactured by mounting components for a microphone function and a component for an ear set function on the PCB 121 via a surface mounting technology (SMT), regardless of a process of manufacturing the microphone cell unit 110, forming the PCB assembly 120, coupling the microphone cell unit 110 formed of an electret to the PCB 121 via laser welding or welding, and then coating an acoustic sealing material or sealing an coupling portion between the microphone cell unit 110 and the PCB 121 by using a gasket, a housing, or the like.

Thus, according to the present embodiment, an SMT process is omitted from a process of mounting the microphone cell unit 110 so as to prevent an electret from being lost due to a high temperature, thereby obtaining excellent sound quality of a microphone.

In addition, since the components for a microphone function and the components for an ear set function are mounted on the upper surface of the PCB 121 and the microphone cell unit 110 is formed to surround all the components mounted on the upper surface, an area of a back electrode plate 114 is increased while obtaining a compact product, thereby increasing the sensitivity of a microphone.

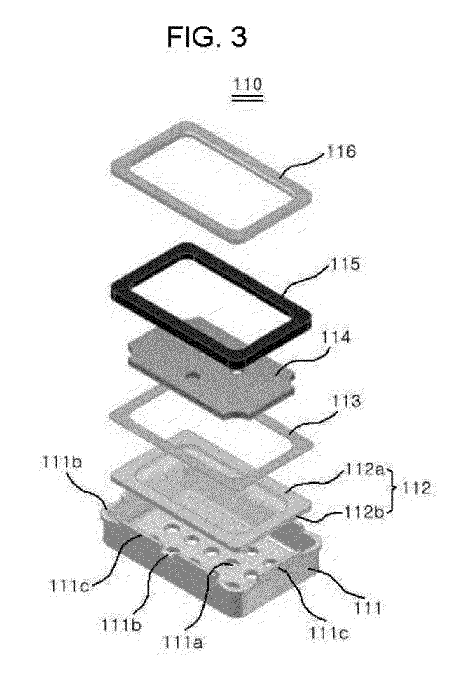

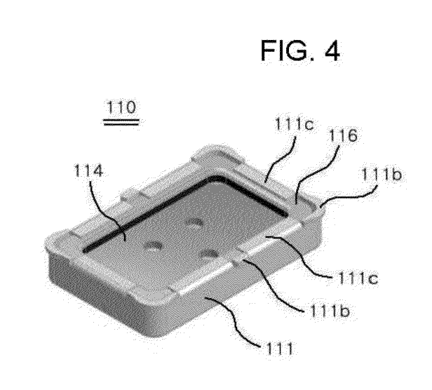

FIG. 3 is an exploded perspective view of a case where the microphone cell unit 110 of FIG. 1 is not assembled, according to an embodiment of the present invention. FIG. 4 is a perspective view of a case where the microphone cell unit 110 of FIG. 1 is assembled, according to an embodiment of the present invention.

As shown in FIGS. 3 and 4, the microphone cell unit 110 includes a microphone cell case 111 including a sound hole 111a and a welding portion 111b, a diaphragm assembly 112 inserted into the microphone cell case 111, a spacer 113 inserted into the microphone cell case 111 and stacked on the diaphragm assembly 112, the back electrode plate 114, an insulating ring base 115, and a metal ring base 116, and has a structure in which four lateral sides of the microphone cell case 111 are fixed by being deformed and folded (that is, a curing or clamping process) via a press structure, wherein the back electrode plate 114 is inserted into the microphone cell case 111, is stacked on the spacer 113, and includes a high-molecular weight materials exhibiting permanent charges, the insulating ring base 115 is inserted into the microphone cell case 111, allows the back electrode plate 114 to be properly positioned, and is formed of a non-conductive material for preventing the microphone cell case 111 from being grounded, and the metal ring base 116 is inserted into the microphone cell case 111, is stacked on the insulating ring base 115, fixes internal components during a curing or clamping process by structurally deforming four lateral sides of the microphone cell case 111, permanently transmits a uniform pressure to the microphone cell case 111, and is formed of metal.

Referring to FIG. 3, the diaphragm assembly 112 includes a diaphragm 112a formed of a thin film, and a diaphragm plate 112b that constitutes a gap between the diaphragm 112a and the case 111 and electrically connects the diaphragm 112a to the case 111.

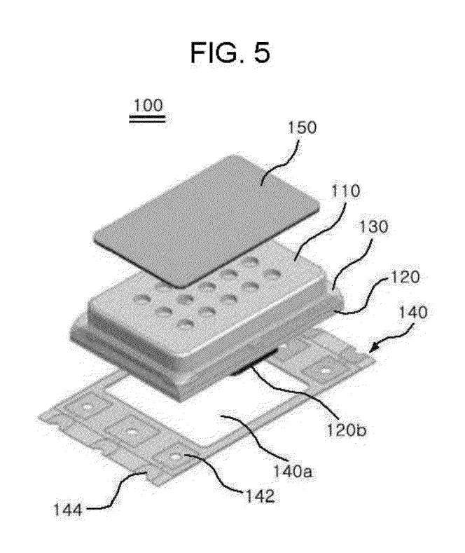

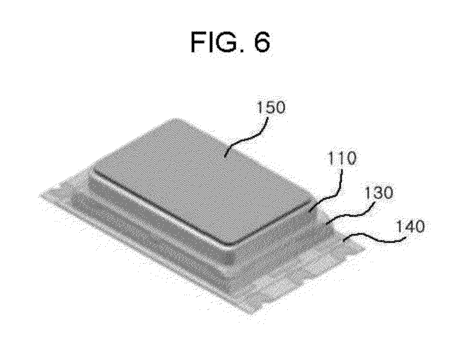

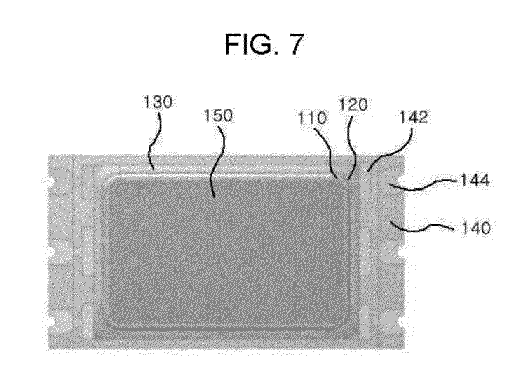

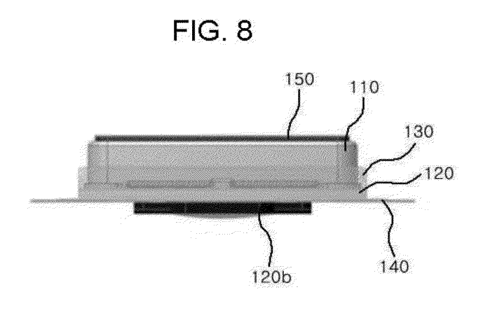

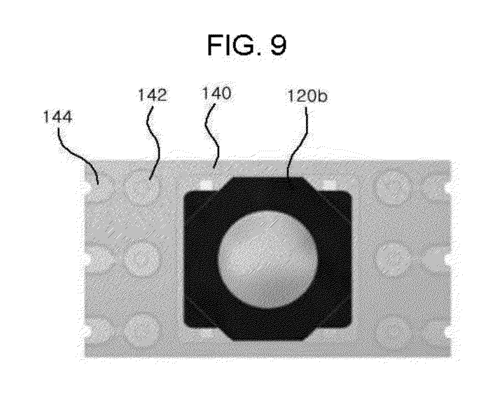

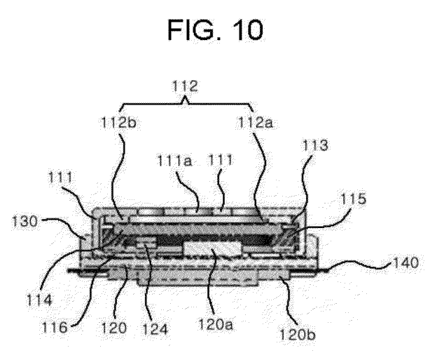

FIG. 5 is an exploded perspective view of a case where a flexible printed circuit board (FPCB) interface of the multi-functional microphone assembly 100 is not assembled, according to an embodiment of the present invention. FIG. 6 is a perspective view of a case where an FPCB interface of the multi-functional microphone assembly 100 is assembled, according to an embodiment of the present invention. FIG. 7 is a plan view of the multi-functional microphone assembly 100 of FIG. 6, according to an embodiment of the present invention. FIG. 8 is a side view of the multi-functional microphone assembly 100 of FIG. 6, according to an embodiment of the present invention. FIG. 9 is a bottom view of the multi-functional microphone assembly 100 of FIG. 6, according to an embodiment of the present invention. FIG. 10 is a side cross-sectional view of the multi-functional microphone assembly 100 of FIG. 6, according to an embodiment of the present invention.

According to the present embodiment, as shown in FIGS. 5 through 10, in the completed multi-functional microphone assembly 100, an entire surface of the case 111 containing the sound hole 111a is surrounded by non-woven fabric 150 in order to prevent dust or moisture from penetrating into the case 111, and a connection terminal of the PCB 121 is adhered to the an FPCB 140 in order to mount the multi-functional microphone assembly 100 on another main board or structure through the FPCB 140. That is, according to the present embodiment, the multi-functional microphone assembly 100 having an FPCB interface includes the microphone cell unit 110, the PCB assembly 120 that is coupled to the microphone cell unit 110 and on which components for a microphone function and components for an ear set function are mounted, the sealing member 130 for sealing a space between the microphone cell unit 110 and the PCB assembly 120, and the FPCB 140 for connecting the multi-functional microphone assembly 100 to another main board or structure.

Referring to FIGS. 5 through 10, the FPCB 140 includes a hole 140a through which the lower mount components 120b mounted on the lower surface of the PCB 121 are exposed, internal connection terminals 142 that contacts the connection terminals 122 that are formed on the lower surface of the PCB 140, and external connection terminals 144 for connection with an external circuit. According to the present embodiment, six connection terminals 122 are formed on the PCB 140, and six internal connection terminals 142 and six external connection terminals 144 are also formed on the FPCB 140 so as to correspond to the six connection terminals 122.

The PCB assembly 120 includes the PCB 121, the conductive member 124 that is mounted on the PCB 121 for connection with the microphone cell unit 110 and electrically connects the microphone cell unit 110 and the PCB assembly 120 to each other, and the upper and lower mount components 120a and 120b that are respectively mounted on the upper surface and the lower surface of the PCB 121. The conductive member 124 may be, for example, a coil spring, a leaf spring, a connector, a socket, a pogo pin, or the like. According to the present embodiment, the conductive member 124 is a leaf spring.

The multi-functional microphone assembly 100 having an FPCB interface is mounted on a main board or a structure via the FPCB 140 and it may serve as a power supply that supplies power to the connection terminal 122 of the PCB 121 via the external connection terminals 144 and the internal connection terminals 142.

One electrode of an external power supplier is connected to the diaphragm assembly 112 through the metal pattern 121a of the PCB 121 and the microphone cell case 111 and the other electrode is connected the back electrode plate 114 through the conductive member 124 of the PCB 121 to charge the diaphragm assembly 112 and the back electrode plate 114.

In addition, when an acoustic signal is input to the microphone cell unit 110 through the non-woven fabric 150 and the sound hole 111a of the case 111, the diaphragm assembly 112 vibrates, and thus an electrostatic capacity between the back electrode plate 114 and the diaphragm assembly 112 is changed. The acoustic signal is transmitted to an FET mounted on the PCB 121 and is processed by the FET. In this case, since components for additional functions such as an ear set function are also mounted on the PCB assembly 120, additional functions (e.g., an ear set function) may be obtained together with the microphone function.

According to the one or more embodiments of the present invention, since a multi-functional microphone assembly may have additional functions such as an ear set, a single product, that is, a microphone may have various functions without using a separate component so as to reduce the number of required components, thereby reducing the fraction defective and volume of the microphone.

In addition, since a multi-functional microphone assembly includes circuit components for other functions, which are mounted on a PCB for a microphone function, an area of a back electrode plate formed of an electret is increased while having a compact structure so as to increase the sensitivity of the multi-functional microphone assembly. Furthermore, interfacing is possible via an FPCB, thereby easily obtaining various interfaces.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A multi-functional microphone assembly comprising:
a microphone cell unit; and
a printed circuit board (PCB) assembly that is coupled to the microphone cell unit and in which components for a microphone function and components for an additional function are mounted on a PCB on which a metal pattern and a connection terminal are formed.

2. The multi-functional microphone assembly of claim 1, wherein the microphone cell unit is welded on the metal pattern, and a connection surface between the microphone cell unit and the PCB assembly is sealed by a sealing member.

3. The multi-functional microphone assembly of claim 1 or 2, further comprising a flexible printed circuit board (FPCB) for interfacing with an external device.

4. The multi-functional microphone assembly of claim 1 or 2, wherein the PCB assembly comprises:
a PCB having one surface on which a metal pattern is formed and the other surface on which a connection terminal is formed,
a conductive member that is mounted on the PCB and electrically connects the microphone cell unit and the PCB assembly to each other,
components for a microphone function, which are mounted on an upper surface of the PCB, and
mount components for additional functions, which are respectively mounted on the upper surface of the PCB and a lower surface of the PCB.

5. The multi-functional microphone assembly of claim 4, wherein the conductive member comprises any one of a coil spring, a leaf spring, a connector, a socket, and a pogo pin.

6. The multi-functional microphone assembly of claim 1 or 2, wherein the microphone cell unit comprises: a microphone cell case comprising a sound hole and a curing portion; a diaphragm assembly inserted into the microphone cell case;
a spacer that is inserted into the microphone cell case and is stacked on the diaphragm assembly; a back electrode plate that is inserted into the microphone cell unit and stacked on the spacer; and an insulating ring base that is inserted into the microphone cell unit, allows the back electrode plate to be properly positioned, and is formed of a non-conductive material for preventing the microphone cell case from being grounded, and
wherein internal components are fixed by a curing or clamping process of the microphone cell case.

7. The multi-functional microphone assembly of claim 6, wherein the microphone cell case further comprises a metal ring base that is inserted into the microphone cell case, is stacked on the insulating ring base, fixes the internal components during the curing or clamping process, permanently transmits a uniform pressure to the microphone cell case, and is formed of metal.

8. A method of manufacturing a multi-functional microphone assembly, the method comprising:
assembling a microphone cell unit;
mounting a conductive member and circuit components on a PCB;
adhering the microphone cell unit to the PCB to each other; and
sealing a connection surface between the microphone cell unit and the PCB assembly.

9. The method of claim 8, further comprising adhering the microphone assembly to an FPCB for interfacing.

10. The method of claim 8 or 9, wherein the assembling of the microphone cell unit comprises:
inserting a microphone cell case comprising a sound hole and a curing portion into a diaphragm assembly;
stacking a spacer on the diaphragm assembly;
inserting a back electrode plate into an insulating ring base to be coupled to each other;
mounting the insulating ring base coupled to the back electrode plate on the spacer;
mounting a metal ring base on the insulating ring base; and
curing or clamping a curing portion of the microphone cell case.
